(19) United States
(12) Patent Application Publication
(10) Pub. No.: US 2012/0267352 A1
(43) Pub. Date: Oct. 25, 2012

(54) Apparatus for the thermal processing of a workpiece

(75) Inventors: Tobias Wolf, Moemlingen (DE); Thomas Duenzkofer, Gross-Umstadt (DE)

(73) Assignee: Messer Cutting Systems GmbH, Gross-Umstadt (DE)

(21) Appl. No.: 13/506,444

(22) Filed: Apr. 19, 2012

(30) Foreign Application Priority Data
Apr. 21, 2011 (DE) 10 2011 018 648.4

(51) Int. Cl. B23K 26/08; B23K 7/10; B23Q 1/44

(52) U.S. Cl. 219/121.82; 269/58; 269/71; 266/77

(57) ABSTRACT

An apparatus for the thermal processing of a workpiece with a thermal processing tool that is adjustable perpendicularly to the workpiece surface has a drive for adjusting the work distance. The drive is in operative communication with the processing tool or part of it, and is configured as a voice coil actuator, comprising a magnet producing a magnetic field, and a coil in the magnetic field. The magnet and coil are movable relative to each other along a movement axis in response to an electric current. To provide a drive for a thermal processing machine that affords a compact structural form and high machine dynamics, the magnet has a cavity, which has arranged therein the processing tool, or a part thereof, which is mechanically connected to the voice coil actuator.

The present invention relates to an apparatus for the thermal processing of a workpiece with a thermal processing tool which is adjustable in a direction perpendicular to the workpiece surface, and with a drive for adjusting a work distance, the drive for the work distance adjustment being in operative communication with the processing tool or a part thereof and configured as a voice coil actuator, comprising a magnet which produces a magnetic field, and with a coil arranged in the magnetic field, with magnet and coil being movable relative to each other along a movement axis in response to an electric current.

The thermal processing of workpieces particularly comprises welding, cutting and surface treatment for producing markings. Depending on the task to be handled, different processing machines and different types of processing tools are used. Various processing tools such as oxyfuel torches, plasma torches or lasers are available for the thermal cutting of workpieces.

The thermal cutting of materials by using an oxyfuel torch is carried out by the combined use of a combustion gas jet and an oxygen gas jet. Material separation is here carried out in that the material is fused in the area of the cutting front by the combustion heat and is expelled by the cutting gas jet out of the cutting front. The thermal cutting of materials by means of a laser beam is carried out by the combined use of a focused laser beam and a gas jet. Depending on the separating mechanism, a distinction is here made between laser-beam fusion cutting, laser-beam evaporation cutting or laser flame cutting.

For a precise cutting of a workpiece it is important that a predetermined distance between the cutting tool and the workpiece is observed. The optimal distance depends on various factors, among these e.g. the workpiece quality and the workpiece thickness. This is true for the cutting by means of oxyfuel torches, wherein the flame produced by the torch has a characteristic temperature distribution, and also for the focal position of the laser beam during thermal cutting by means of a laser beam.

### PRIOR ART

Many methods and apparatuses are known for adjusting and maintaining the optimal distance.

For instance, DE 195 03 758 A1 discloses a driving device for the vertical adjustment of a burner of a gas cutting machine, wherein an electric motor type drive serves to adjust the distance between the tool (cutting head) and the workpiece. An electric motor in combination with a threaded spindle is used as the drive.

DE 699 26 679 T2 discloses a method for adjusting the focal point position of a laser beam of a laser cutting machine, which is accomplished by varying the distance between a converging lens and an exit nozzle. The converging lens is locally fixed. A drive mechanism moves the laser head upwards and downwards independently of the converging lens, whereby the distance between the converging lens and the exit nozzle is set. A motor which drives a ball screw is used as the drive device for the laser head.

Electric motors require some space, produce imbalances and contribute to a greater structural form of the apparatus, resulting in low machine dynamics.

As an alternative to electric motors, so-called voice coil actuators have become popular, especially when the generation of precise linear movements is of importance.

Such a voice coil actuator is e.g. suggested in EP 0 868 962 A2 for the three-dimensional movement of a tool. Shifting platforms are provided for movement in the horizontal plane, each platform being arranged between two voice coil actuators. Only one voice coil actuator on which the tool is mounted is provided for movement in the vertical direction.

A method and a generic apparatus in the form of a thermal processing machine for the processing of wafers by means of a laser are known from U.S. 2005/0184036 A1. The voice coil actuator is here provided for focusing the lens system along the optical axis, and voice coil actuators are here arranged next to and also above or below the lens system.

### TECHNICAL OBJECT

The arrangement of the tool between two voice coil actuators and also the separate arrangement of the voice coils above, below or next to the lens require a lot of space and may contribute to imbalances in the case of fast movements.

It is therefore the object of the present invention to provide a drive for a thermal processing machine that affords a compact structural form and high machine dynamics.

### GENERAL DESCRIPTION OF THE INVENTION

This object, starting from an apparatus of the aforementioned type, is achieved according to the invention in that the magnet comprises a cavity which has arranged therein the processing tool, or a part thereof, which is mechanically connected to the voice coil actuator.

In the apparatus according to the invention a voice coil actuator is provided for adjusting the work distance during the thermal processing of workpieces. Voice coil actuators are per se known from the prior art. The drive movement is based on the fact that a current carrying coil is moveable in a magnetic field relative to the magnetic field lines. The drive movement is here carried out either by movement of the coil itself or of the magnet producing the magnetic field. In contrast to a distance adjustment e.g. by means of motor and threaded spindle, the use of the voice coil actuator provides for a particularly compact and lightweight structural form of the apparatus. Voice coil actuators are not very prone to wear, produce no abrasion and permit a fast dynamic adjustment of the work distance.

An essential feature of the invention consists in that the voice coil actuator comprises a cavity which has arranged therein the processing tool, or a part thereof, which is in operative communication with the voice coil actuator. The tool part accommodated within the cavity would otherwise have to be arranged outside the voice coil actuator. This arrangement therefore permits a particularly compact structural form. The processing tool or a part thereof is completely enclosed by the voice coil, but it may also project out of the cavity.

In the simplest case the processing tool or a part thereof is moveably arranged inside the cavity. However, it is also possible to mount it such that it is immovable within the cavity; in this case an outer part of the tool that is not arranged in the cavity has to be movable from the top or from the bottom by means of the voice coil actuator so as to effect a change in distance.

The processing tool is e.g. a laser or a torch. The coil has a one-part or multi-part configuration. In the simplest case the magnet is a ring magnet. However, the magnet may also be composed of a plurality of ring magnets or of a plurality of magnetic components. The magnet may also be a coil.

To achieve enhanced machine dynamics and to avoid imbalances, it has turned out to be particularly advantageous when the processing tool or a part thereof is guided along a movement axis and the voice coil actuator is symmetrically arranged about this movement axis.

It has turned out to be advantageous when the mechanical connection is established by means of a shifting element projecting into the cavity, particularly a sleeve.

The shifting element serves to fasten the processing tool or a part thereof and can simultaneously be used as an adapter for different dimensions of the processing tool or a part thereof.

According to a preferred variant of the apparatus the cavity is configured as an inner bore of a permanent magnet.

In contrast to the generation of a magnetic field e.g. by means of solenoids, no further electrical supply and no control are needed for the magnet if a permanent magnet is used.

Preferably, for the adjustment of the work distance a first device is provided for the coarse adjustment and a second device for the tine adjustment, the first device comprising a coarse adjustment drive and the second device comprising a fine adjustment drive which is formed by the voice coil.

The coarse adjustment and the fine adjustment are preferably carried out at different speeds. To adjust the work distance, a coarse adjustment is first carried out, and the fine adjustment is then performed by means of the voice coil actuator. A high speed during coarse adjustment will shorten the setup time; the dynamic fine adjustment makes it possible that even minor irregularities of the workpiece that lead to inaccuracies in the cutting process can rapidly be taken into account.

It has turned out to be useful when the cavity is made uninterruptedly cylindrical and has a diameter in the range of 20 mm to 70 mm.

A continuous cavity can be manufactured easily. Thermal processing operations typically use tools that have lateral dimensions of more than 20 mm. In the case of a cavity diameter of less than 20 mm, these common tools would no longer be operable with the drive according to the invention. Diameters of more than 150 mm result in heavy weights for the drive, such weights reducing the machine dynamics.

It has turned out to be useful when the stroke range of the voice coil actuator is 5 mm to 30 mm.

This stroke range is particularly suited for fine adjustment In an advantageous configuration of the apparatus the processing tool is a laser which comprises at least one lens which as part of the processing tool is mechanically connected to the voice coil actuator and is arranged in the cavity.

The arrangement of the lens within the cavity of the voice coil actuator permits a particularly compact structure of the drive of the focusing unit of the laser. It can be integrated into a bevel-suited laser head with lateral lens adjustment. The positioning of the lens relative to the workpiece surface or of another beam-forming optical component is regulated for the focusing of the laser beam by means of the voice coil actuator and permits short setup times.

In a preferred modification of this embodiment, it is provided that the lens is connected to the movably supported coil of the voice coil actuator.

In this case the lens is supported within the cavity of the magnet to be movable along the movement axis and is moved by means of the coil. The mechanical connection between lens and coil is e.g. established by means of a sleeve or a linkage which projects into the cavity and is movable along the movement axis and which serves to hold the lens at the same time.

In an alternative, equally preferred modification, it is provided that the lens is connected to the movably supported magnet of the voice coil actuator.

In this case, too, the lens is supported within the cavity of the magnet to be movable along the movement axis and it is moved by means of the magnet. The mechanical connection between lens and magnet is e.g. established by means of a sleeve or a linkage which projects into the cavity and is movable along the movement axis and which simultaneously serves to hold the lens.

In the two last-mentioned apparatus variants, it is taken into account that the coil and the magnet of the voice coil actuator are movable relative to one another and that the processing tool or a part thereof can be fastened to the coil and also to the magnet.

It has turned out to be advantageous when the voice coil actuator comprises a pressure window which seals the cavity outwardly.

This permits a dynamic adjustment of the work distance also in the case of increased or lowered gas pressures outside the cavity, as occur e.g. during the cutting process (so-called cutting pressure).

In a further advantageous configuration of the apparatus, the processing tool is a torch which comprises a torch shaft and a torch head connected to the torch shaft, the torch shaft being mechanically connected to the voice coil actuator and projecting through the cavity.

The torch is a torch for welding, cutting, marking, soldering or scarfing.

The invention will now be described in more detail with reference to embodiments and a drawing. The drawing shows in detail in schematic representation in:

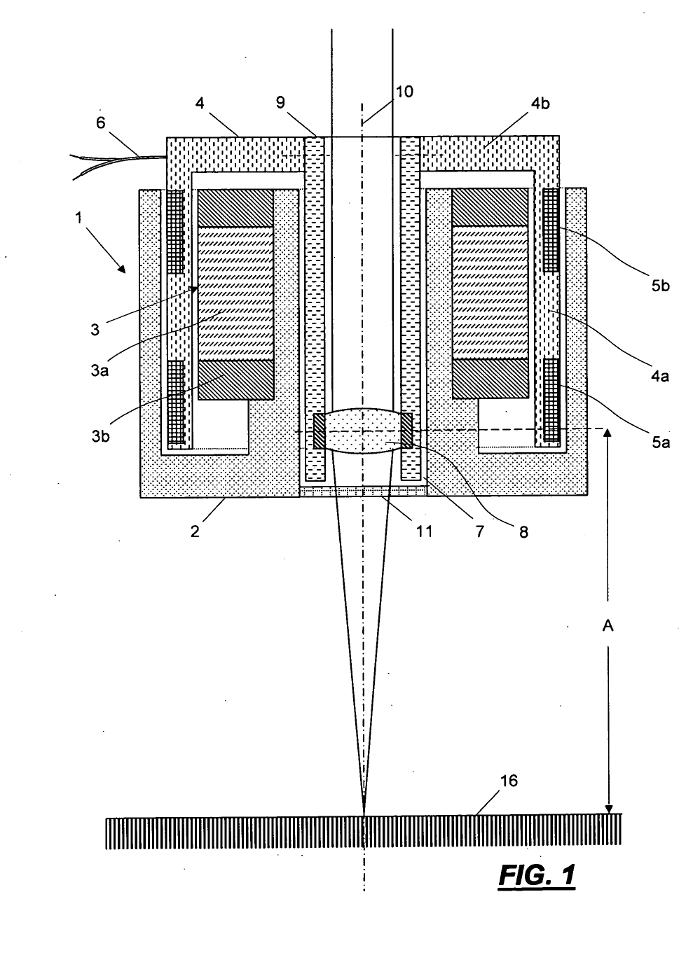

FIG. 1 a first embodiment of the apparatus according to the invention with voice coil actuator for a processing machine for thermal laser processing;

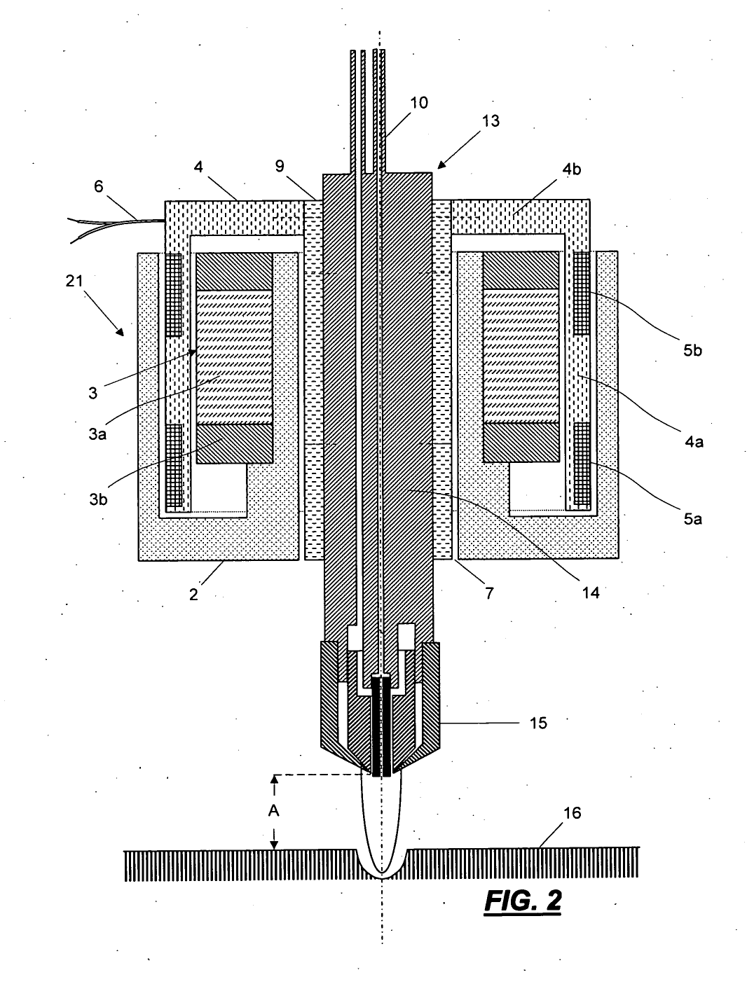

FIG. 2 a second embodiment of the apparatus according to the invention with voice coil actuator for a gas cutting machine with cutting torch; and

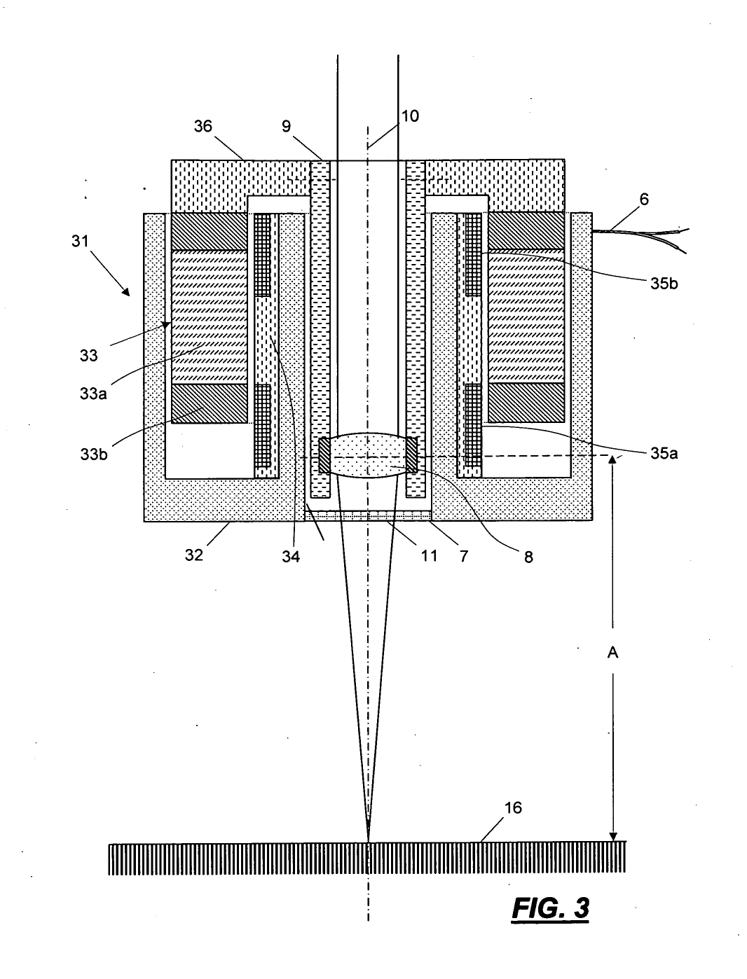

FIG. 3 a third embodiment of the apparatus according to the invention with an alternative voice coil actuator for a processing machine for thermal laser processing.

FIG. 1 shows a drive for focusing a laser beam of a laser processing machine in the form of a voice coil actuator, which has reference numeral 1 assigned to it on the whole. The voice coil actuator 1 is composed of a housing part 2 in which a permanent magnet 3 with a north pole 3a and a south pole 3b is stationarily supported. The magnet 3 produces a magnetic field in which two coils 5a, 5b are positioned that in the direction of the movement axis 10 are fastened to a carrier 4 in spaced-apart relationship with each other. The carrier 4 comprises a surrounding sidewall 4a which is connected to an inwardly projecting flange 4b. The carrier 4 grips over the magnet in the manner of a bracket. The sidewall 4a of the carrier 4 serves to receive the coils 5a, 5b. The carrier 4 has mounted thereon a connection element in the form of a sleeve 9 which, while leaving an annular work air gap, projects into the cavity 7 and is freely movably supported along the movement axis 10. Both coils 5a, 5b are connected via connections 6 to a voltage source (not shown).

It is essential for the present invention that the housing 2 encompasses a centric cylindrical cavity 7 which has arranged therein a framed lens 8 which serves to focus the laser beam. The lens 8 is mounted in the sleeve 9 which can be moved upwards and downwards within the cavity 7 along the movement axis 10. The sleeve 9 is screwed with the flange 4b. When current is applied to the coils 5a, 5b, a force will act on the coils 5a, 5b due to the Lorentz force and the carrier 4 and the sleeve 9 together with the lens 8 mounted therein will be moved thereby. With the control of the current, the work distance A between the lens 8 and the workpiece surface 16 and thus the focal position of the laser beam is set. The cavity 7 is sealed by a pressure window 11 to the outside, thereby preventing the penetration of cutting gases into the cavity 7 and damage to the lens 8.

The maximal stroke of the coils 5a, 5b in the work gap is 20 mm. The outer diameter of the whole voice coil actuator 1 is 110 mm and the height in the non-extended state is 115 mm. The inner diameter of the cavity 7 is 63 mm and the outer diameter of the sleeve 9 is 60 mm and its inner diameter 54 mm. The carrier 4 and the sleeve 9 consist of aluminum. The lens 8 is a focusing lens of quartz glass. The actuator 1 is designed for a peak force of up to 120 N. It ensures a high repeat and positioning accuracy in the nanometer range and is free of hysteresis.

As far as FIGS. 2 and 3 use the same reference numerals as FIG. 1, these designate structurally identical or equivalent members and components as have been explained above in more detail with reference to the description of the first embodiment of the voice coil actuator according to the invention.

FIG. 2 shows a second embodiment of the apparatus according to the invention in which a torch 13 is used as the processing tool. The torch 13 consists of a torch shaft 14 and a torch head 15. It is essential for the present invention that the torch shaft 14 extends through the central cavity 7 of the voice coil actuator 21.

The voice coil actuator 21 is used for adjusting the work distance A between torch 13 and workpiece surface 16 and is symmetrically arranged about the torch shaft 14 in the embodiment.

The voice coil actuator 21 is composed of a surrounding housing part 2 of U-shaped cross-section in which a permanent magnet 3 with a north pole 3a and a south pole 3b is stationarily supported. The magnet 3 produces a magnetic field in which two coils 5a, 5b are positioned that when, viewed in the direction of the movement axis, are arranged one above the other and spaced apart from each other and are fastened to a carrier 4. The carrier 4 comprises a surrounding sidewall 4a which is connected to an inwardly projecting flange 4b. The carrier 4 grips over the magnet in the manner of a bracket. The sidewall 4a serves to receive the coils 5a, 5b. Both coils 5a, 5b are connected via connections 6 to a voltage source (not shown). A sleeve 9 which projects into the cavity 7 and is freely movably supported along the movement axis 10 is mounted on the flange 4b.

The sleeve 9 is screwed to both the carrier 4 and the torch shaft 14. When current is applied to the coils 5a, 5b, a force will act on the coils 5a, 5b due to the Lorentz force and the carrier 4, the sleeve 9 and also the torch 13 mounted therein will be moved thereby along the movement axis 10. Due to the control of the current on the coils 5a, 5b, the distance of the torch 13 from the workpiece surface 16 is set.

The maximal stroke of the coils 5a, 5b in the work gap is 25 mm. The outer diameter of the whole voice coil actuator 21 is 135 mm and the height in the non-extended state is 130 mm. The inner diameter of the cavity 7 is 63 mm and the outer diameter of the sleeve 9 is 60 mm and its inner diameter 54 mm. The carrier 4 and the sleeve 9 consist of aluminum. The torch is an oxyfuel cutting torch. The actuator is designed for a peak force of up to 1,110 N. It ensures a high repeat and positioning accuracy in the nanometer range and is free of hysteresis.

FIG. 3 shows a third embodiment of the apparatus according to the invention with an alternative voice coil actuator 31 for a processing machine for thermal laser treatment. The voice coil actuator 31 is composed of a housing part 32 in which two coils 35a, 35b are stationarily supported and spaced apart in the direction of the movement axis and positioned one above the other. The coils 35a, 35b are fastened to a carrier 34 and produce a magnetic field in which a magnet 33 with a north pole 33a and a south pole 33b is positioned. The magnet 33 is connected to a carrier 36 on which, in turn, a connection element is mounted in the form of a sleeve 9 which, while leaving an annular work air gap, projects into the cavity 7 and is freely movably supported along the movement axis 10. Both coils 35a, 35b are connected via the connections 6 to a voltage source (not shown).

It is essential for the invention that the housing 32 encompasses a centric cylindrical cavity 7 which has arranged therein a framed lens 8 which serves to focus the laser beam. The lens 8 is mounted in the sleeve 9 which can be moved upwards and downwards within the cavity 7 along the movement axis 10. The sleeve 9 is screwed with the carrier 36. When current is applied to the coils 35a, 35b, a force will act on the magnet 33 due to the Lorentz force and the carrier 36 and the sleeve 9 together with the lens 8 mounted therein will be moved thereby. With the control of the current, the work distance A between the lens 8 and the workpiece surface 16 and thus the focal position of the laser beam is set. The cavity 7 is sealed by a pressure window 11 to the outside, thereby preventing the penetration of cutting gases into the cavity 7 and damage to the lens 8.

The maximal stroke of the coils 35a, 35b in the work gap is 20 mm. The outer diameter of the whole voice coil actuator 31 is 110 mm and the height in the non-extended state is 115 mm. The inner diameter of the cavity 7 is 63 mm and the outer diameter of the sleeve 9 is 60 mm and its inner diameter 54 mm. The carrier 4 and the sleeve 9 consist of aluminum. The lens 8 is a focusing lens of quartz glass. The actuator 31 is designed for a peak force of up to 120 N. It ensures a high repeat and positioning accuracy in the nanometer range and is free of hysteresis.

1. An apparatus for the thermal processing of a workpiece, the apparatus comprising:
a thermal processing tool which is supported so as to be adjustable in a direction perpendicular to a surface of the workpiece, and
a drive adjusting a work distance of the thermal processing tube from the surface,
the drive adjusting the work distance being in operative communication with the processing tool or a part thereof using a voice coil actuator, comprising a magnet that produces a magnetic field, and a coil arranged in the magnetic field, said magnet and said coil being movable relative to each other along a movement axis in response to an electric current,
wherein the magnet has a cavity, and the processing tool, or a part thereof being supported in the cavity and being mechanically connected to the voice coil actuator.

2. The apparatus according to claim 1, wherein the processing tool, or parts thereof, is guided along the movement axis, and that the voice coil actuator is symmetrically arranged about said movement axis.

3. The apparatus according to claim 1, wherein the mechanical connection is established using a shifting element projecting into the cavity.

4. The apparatus according to claim 1, wherein the magnet is a permanent magnet having an inner bore defining said cavity.

5. The apparatus according to claim 1, wherein the adjustment of the work distance is accomplished using a first device providing the coarse adjustment and a second device providing fine adjustment, the first device comprising a coarse adjustment drive and the second device comprising a fine adjustment drive which is formed by the voice coil.

6. The apparatus according to claim 1, wherein the cavity is continuously cylindrical and has a diameter in the range of 20 mm to 70 mm.

7. The apparatus according to claim 1, wherein the voice coil actuator has a stroke range of 5 mm to 30 mm.

8. The apparatus according to claim 1, wherein the processing tool includes is a laser that comprises at least one lens which as part of the processing tool is mechanically connected to the voice coil actuator and is arranged in the cavity.

9. The apparatus according to claim 8, wherein the lens is connected to the movably supported coil of the voice coil actuator.

10. The apparatus according to claim 8, wherein the lens is connected to the movably supported magnet of the voice coil actuator.

11. The apparatus according to claim 8, wherein the voice coil actuator comprises a pressure window that seals the cavity outwardly.

12. The apparatus according to claim 1, wherein the processing tool is a torch, which comprises a torch shaft and a torch head connected to the torch shaft, the torch shaft being mechanically connected to the voice coil actuator and projecting through the cavity.

13. The apparatus according to claim 1, wherein the mechanical connection is established by means of a sleeve projecting into the cavity.
